(19) United States
(12) Patent Application Publication
(10) Pub. No.: US 2023/0231316 A1
(43) Pub. Date: Jul. 20, 2023

(54) DIELECTRIC CYLINDRICAL LENS AND DIELECTRIC FILM, FABRICATION METHOD OF DIELECTRIC CYLINDRICAL LENS

(71) Applicant: BEIJING HIGH WAY TELECOMMUNICTION TECHNOLOGY CO., LTD., Beijing (CN)

(72) Inventors: Chenxi LV, Beijing (CN); Wei HUANG, Beijing (CN)

(21) Appl. No.: 18/007,921

(22) PCT Filed: May 23, 2021
(86) PCT No.: PCT/CN2021/095358

§ 371 Date: Dec. 2, 2022

(30) Foreign Application Priority Data
Jun. 28, 2020 (CN) 202010597042.3

(51) Int. Cl. H01Q 15/08

(52) U.S. Cl. CPC H01Q 15/08

(57) ABSTRACT

The invention discloses a kind of dielectric cylindrical lens, dielectric film and fabrication method of dielectric cylindrical lens, which solves the problems of poor parameter consistency, large scattering and much two-way communication interference of the existing antennas. A dielectric cylindrical lens, whose lens structure is a cylinder concentrically wound by dielectric materials. The dielectric material contains the dielectric film, and the dielectric film is fabricated by mixing ceramic powder into cellulose solution or paper pulp. A kind of fabrication method of the dielectric cylindrical lens, which takes the preset dielectric constant of each layer of the dielectric lens as the target equivalent dielectric constant of a composite layer structure, adjusts the dosage of ceramic powder to make a dielectric film or composite layer structure which meets the target equivalent dielectric constant, and concentrically winds the dielectric film or composite layer structure into a cylinder.

This application claims the priority of the China patent application filed in China National Intellectual Property Administration on Jun. 28, 2020, with the application number of 202010597042.3 and the invention title of “Dielectric Cylindrical Lens, Dielectric Film and Fabrication Method of Dielectric Cylindrical Lens”, the entire contents of which are incorporated into this application by reference

### 1. TECHNICAL FIELD

The invention relates to the field of antennas, in particular to the dielectric cylindrical lens, dielectric film and the fabrication method of the dielectric cylindrical lens.

### 2. BACKGROUND ART

The dielectric lens is a component used in the communication antenna. The traditional Luneberg lens antenna is made by two processes: punching and foaming. The punching method is difficult for technicians and the foaming method has a low dielectric constant. Other antennas made of special materials have a higher material density. The patent application 2017112204.2 proposes an artificial dielectric multilayer cylindrical lens with a low density, which is composed of N concentric layers, each of which contains a base material with a low dielectric constant and an additive material with a high dielectric constant and low specific gravity. The base material is the light foaming material which is generally plastic. Adding different types or quantities of additive materials in plastic production will complicate the process. If the additive is spread on the surface of the substrate, it is not easy to control the uniformity, and the particles of additive materials distributed on the surface of the substrate will also cause scattering, which will affect the electromagnetic performance.

### 3. SUMMARY OF THE INVENTION

The invention provides the dielectric cylindrical lens, dielectric film and fabrication method of the dielectric cylindrical len, which solve the problems of poor parameter consistency, large scattering and much two-way communication interference of the existing antenna. To solve the above problems, the invention is realized as follows:

First, the embodiment of the invention points out a dielectric cylindrical lens, the lens structure is a cylinder concentrically surrounded by dielectric materials. The dielectric material is a dielectric film or a composite layer structure containing the dielectric film, and the dielectric film is made by mixing ceramic powder into cellulose dissolving liquid or paper pulp, and the made dielectric film reaches the target dielectric constant.

Further, the dielectric material also comprises a low-dielectric-constant base material, and the low-dielectric-constant base material and the dielectric film are combined into a composite layer structure by epoxy resin glue.

Further, the dielectric constant of the dielectric film gradually decreases along the radial direction of the cylinder.

Preferably, the ceramic powder is the titanate ceramic powder.

Preferably, the dielectric cylindrical lens has a height of 20-70 cm and a diameter of 20-90 cm.

Preferably, the low-dielectric-constant base material is sponge foamed paper with a thickness of 0.5-5 mm, and the thickness of the composite layer structure is 0.6-12 mm.

Secondly, the embodiment of the invention also points out a method for fabricating a dielectric film, which is used for fabricating the dielectric film of the dielectric cylindrical lens, and comprises the following steps: Add cellulose solution into ceramic powder to produce the regenerated cellulose film, immerse the regenerated cellulose film in epoxy resin or acetone solution, and obtain the dielectric film by hot curing.

Thirdly, the embodiment of the invention also points out a method for fabricating a dielectric film, which is used for fabricating the dielectric film of the dielectric cylindrical lens, and comprises the following steps: Add cellulose solution into ceramic powder, mechanically stir to mix ceramic powder particles in cellulose slurry, wash with water to remove particles that do not enter the cavity, and prepare the dielectric film through sol, gel and drying.

Fourthly, the embodiment of the invention also points out a method for fabricating a dielectric cylindrical lens, which uses the dielectric film and comprises the following steps: Take the preset dielectric constant of each layer of the dielectric lens as the target equivalent dielectric constant of the dielectric material, adjust the dosage of ceramic powder to prepare a dielectric film that meets the target equivalent dielectric constant, take the dielectric film as the dielectric material, and wind the dielectric material concentrically into a cylinder.

The embodiment of the invention also points out a fabrication method of the dielectric cylindrical lens, which comprises the following steps: Take the preset dielectric constant of each layer of the dielectric lens as the target equivalent dielectric constant of the dielectric material. Make the dielectric film and the low-dielectric-constant base material into the composite layer structure, and adjust the combination ratio of the dielectric film and the low-dielectric-constant base material to make the composite layer structure conform to the target equivalent dielectric constant. Concentrically wind the composite layer structures with different specifications into cylinders.

The invention has these advantageous effects: For the dielectric cylindrical lens provided by the invention, the dielectric film is made of composite materials according to the method of the invention, and the composite layer structure is made of the dielectric film and sponge foamed paper. The dielectric film or composite layer structure made of dielectric film is used in the making of the dielectric cylindrical lens, which allows the dielectric constant of the dielectric cylindrical lens to be distributed stably and accurately, and which has the advantage of low loss.

### 4. BRIEF DESCRIPTION OF ACCOMPANY DRAWINGS

The drawings illustrated here are used to provide a further understanding of the invention and form a part of the invention. The illustrative embodiments of the invention and their descriptions are used to explain the invention, and do not constitute undue limitations on the invention. In the attached drawings:

FIG. 1 is an embodiment of a dielectric cylindrical lens;

FIG. 2 is an embodiment of a composite layer structure;

FIG. 3 (a) is an embodiment of the dielectric constant of dielectric materials with equal thickness distribution of dielectric constant of dielectric film;

FIG. 3 (b) is an embodiment of the dielectric constant of dielectric materials with unequal thickness distribution of dielectric constant of dielectric film;

FIG. 4 is an embodiment of a fabrication method and procedure of the dielectric cylindrical lens;

FIG. 5 is an embodiment of a fabrication method and procedure of the dielectric cylindrical lens containing low-dielectric-constant base materials.

### 5. SPECIFIC EMBODIMENT OF THE INVENTION

In order to make the purpose, technical scheme and advantages of the invention clearer, the technical scheme of the invention will be clearly and completely described below with reference to specific embodiments of the invention and corresponding drawings. Obviously, the described embodiments are only some but not all of the embodiments of the invention. Based on the embodiments of the invention, all other embodiments obtained by ordinary technicians in this field without creative labor are within the scope of protection of the invention.

The innovation points of the invention are as follows: First, the invention adds ceramic powder into cellulose solution or paper pulp to prepare the cellulose composite dielectric film with required dielectric constant, so that the dielectric constant of the dielectric film is accurate and stable in distribution. Secondly, according to the invention, a composite layer structure is formed by winding a dielectric film or alternately winding a dielectric film and a low-dielectric-constant base material, and the artificial cylindrical dielectric lens formed by the method meets the set equivalent dielectric constant distribution, and the dielectric constant is distributed stably and accurately with a low loss.

With reference to the following drawings, the technical schemes provided by various embodiments of the invention are described in detail below.

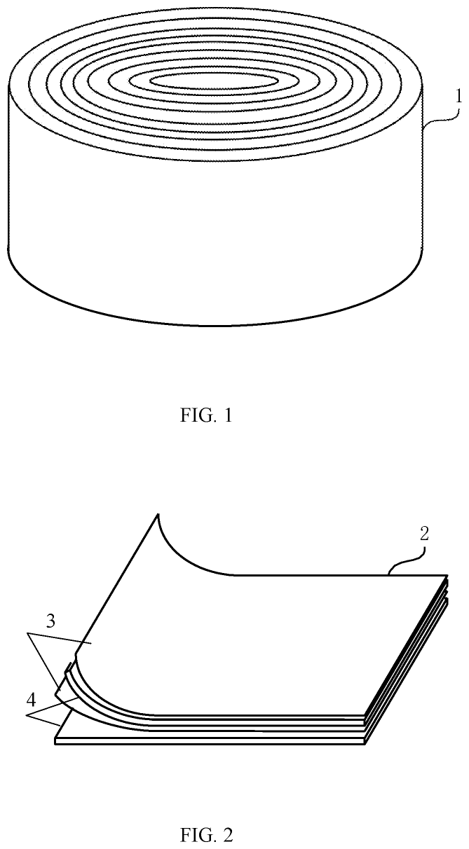

FIG. 1 shows an embodiment of a dielectric cylindrical lens, which adopts a dielectric film made of composite materials. As an embodiment of the invention, a dielectric cylindrical lens 1 has a lens structure of a cylinder concentrically wound by dielectric materials. The dielectric material comprises a dielectric film, and the dielectric film is made by mixing ceramic powder into cellulose solution or paper pulp, and then making it using the papermaking technology or aerogel technology.

In an embodiment of the invention, the dielectric material is a dielectric film or a composite layer structure containing the dielectric film. In the fabrication process of the dielectric film, ceramic powder is mixed into cellulose solution or paper pulp, so that the fabricated dielectric film reaches the target dielectric constant, and the target dielectric constant is the preset dielectric constant of each layer of the dielectric cylindrical lens.

It should be noted that the composite layer structure in the application of the invention refers to a structure made of one or more composite materials, and the dielectric material is a composite layer structure containing only the dielectric film or a composite layer structure containing a dielectric film and a base material. When the dielectric material only contains the dielectric film, the number of layers of the dielectric film is one or more. When the dielectric material comprises a dielectric film and a base material, the number of layers of the dielectric film is one or more, the number of layers of the base material is one or more, and the number of layers of the dielectric film and the base material can be the same or different.

In the invention application, the lens structure is concentrically wound by the dielectric materials, and the lens structure is concentrically wound by N dielectric materials to form a cylinder, each dielectric material is a layer of the lens structure, and the dielectric materials form the 1st-Nth layers of the lens structure along the radial direction of the cylinder from the center to the surface. Here, the dielectric material constituting the lens structure is a composite layer structure, which comprises at least one or more dielectric films, and further comprises one or more base materials. Specifically, when the composite layer structure comprises multiple dielectric films, the dielectric constants of each dielectric film can be the same or different.

That is, in the invention application, “layer” has three meanings: The “layer” of the dielectric cylindrical lens, layer of the dielectric film and layer of the base material. Specifically, the dielectric cylindrical lens is of a multi-layer concentric cylindrical structure with discrete equivalent dielectric constants, and each layer of the concentric cylinder of the dielectric cylindrical lens has the same equivalent dielectric constant inside, and the concentric cylinder is the dielectric material with a composite layer structure. The dielectric material comprises one or more dielectric films, or further comprises one or more layers of low-dielectric-constant base materials.

The dielectric constants in the invention application are all relative dielectric constants. It should be noted that the equivalent dielectric constant is to replace the non-uniformly distributed dielectric constant with the uniformly distributed equivalent dielectric constant, and the equivalent dielectric constant in the invention application is a relative dielectric constant.

The target dielectric constant and the target equivalent dielectric constant in the invention application are generally described as follows: The target dielectric constant and the target equivalent dielectric constant are the dielectric constants that must be met by the dielectric materials of each layer of the composite layer structure of the dielectric cylindrical lens of the invention. When the dielectric material only contains one or more layers of dielectric films, and each layer of dielectric film is made of the same composite material, the target dielectric constant is used to represent the dielectric constant that each layer of dielectric material of the cylindrical lens must meet. When the dielectric material comprises multiple layers of dielectric films, and at least one layer of dielectric film is different from other layers of dielectric films, the equivalent target dielectric constant is used to represent the dielectric constant that each layer of dielectric material of the cylindrical lens must meet. When the dielectric material comprises one or more layers of dielectric films, and also comprises one or more layers of base materials, the equivalent target dielectric constant is used to represent the dielectric constant that each layer of dielectric material of the cylindrical lens must meet.

In the embodiment of the invention, the dielectric film is made using the pulp and paper technology or cellulose aerogel technology, and is used with ceramic powder to produce a cellulose composite layer structure. The thickness of the dielectric film is 0.1-1 mm. In the embodiment of the invention, the dielectric constant of the dielectric film made of pulp and paper is generally above 2, which can reach the range of 3-50, and the dielectric constant of the dielectric film made using the cellulose aerogel technology can be 1.05-2.05.

In the embodiment of the invention, the dielectric cylindrical lens is a multilayer mixed-material artificial dielectric cylindrical lens. Specifically, the dielectric constant of the dielectric film gradually decreases along the radial direction of the cylinder.

In the embodiment of the invention, the ceramic powder is preferably high-dielectric-constant ceramic powder, and titanate ceramic powder has a high dielectric constant, such as barium titanate and calcium titanate. The materials and dielectric constants of the usable ceramic powder are as follows: aluminosilicate 4-7, alumina 8-9, titanium dioxide and titanate 15-10000, silica SiO2 4-5, barium titanate BaTiO3: about 2000, and calcium titanate CaTiO3: 165.

The embodiment of the invention provides a dielectric cylindrical lens, the dielectric material has a composite layer structure, and the dielectric constant is distributed stably and uniformly. Preferably, the cylindrical lens has a height of 20-70 cm and a diameter of 20-90 cm.

Figure is an embodiment of a dielectric material structure, which is a composite layer structure containing low-dielectric-constant base materials. In the embodiment of the invention, the lens structure of the dielectric cylindrical lens is a cylinder concentrically wound by a composite layer structure. For example, one composite layer structure 2 includes a dielectric film 3 and a low-dielectric-constant base material 4.

The low-dielectric-constant base material and the dielectric film can be combined into the composite layer structure by epoxy resin glue.

Preferably, the low-dielectric-constant base material is sponge foamed paper, which forms a composite layer structure with the dielectric film. As the dielectric material in the embodiment of the invention, the composite layer structure is used to adjust the equivalent dielectric constant. Materials of sponge foamed paper are polystyrene, polyvinyl chloride and polyethylene, etc. Optimally, EPE materials are used. The thickness of sponge foamed paper is 0.5-5 mm, and the thickness of the composite layer structure is 0.6-12 mm.

In the embodiment of the invention, in the composite layer structure, the number of layers of the dielectric film and the low-dielectric-constant base material is greater than or equal to 1. That is, the dielectric material is composed of a composite layer structure, and each composite layer contains at least one layer of dielectric film, or further contains at least one layer of sponge foamed paper, so that the prepared composite layer structure can reach the target equivalent dielectric constant, which can be, for example, 1.05-2.05.

It should be noted that the composite layer structure is composed of dielectric films with different dielectric constants, or dielectric films with different dielectric constants and low-dielectric-constant base materials, so the equivalent dielectric constant is used to describe the dielectric constant of the composite layer structure. The “low dielectric constant” in the low-dielectric-constant base material refers to the dielectric constant that is smaller than the dielectric film. For example, a material with a dielectric constant between 1 and 1.1 can be chosen as the base material.

Further, the dielectric film and the low-dielectric-constant base material can be combined into:

For example, a standard composite layer structure is made of two layers of dielectric films and two layers of foamed sponge paper, with the thickness of each layer of dielectric film being 0.5 mm, the thickness of each layer of foamed sponge paper being 2 mm, the total thickness being 5 mm, the dielectric constant of the dielectric film being 3.5, and the equivalent dielectric constant being 1.5.

For another example, a standard composite layer structure is made of three layers of dielectric films and three layers of foamed sponge paper, with the thickness of each layer of dielectric film being 0.1 mm, the thickness of each layer of foamed sponge paper being 2 mm, the total thickness being 6.3 mm, the dielectric constant of the dielectric film being 17.8, and the equivalent dielectric constant being 1.8.

For another example, a standard composite layer structure is made of one layer of dielectric films and three layers of foamed sponge paper, with the thickness of each layer of dielectric film being 0.1 mm, the thickness of each layer of foamed sponge paper being 2 mm, the total thickness being 6.1 mm, the dielectric constant of the dielectric film being 2.88, and the equivalent dielectric constant being 1.08.

When the composite layer structure provided by the embodiment of the invention is compounded by a dielectric film and a low-dielectric-constant base material, the composite layer structure of the required target equivalent dielectric constant can be obtained by adjusting the layer number and thickness ratio of the dielectric film and the low dielectric constant; And then concentric winding with the composite layer structure is performed to form the lens body of the invention.

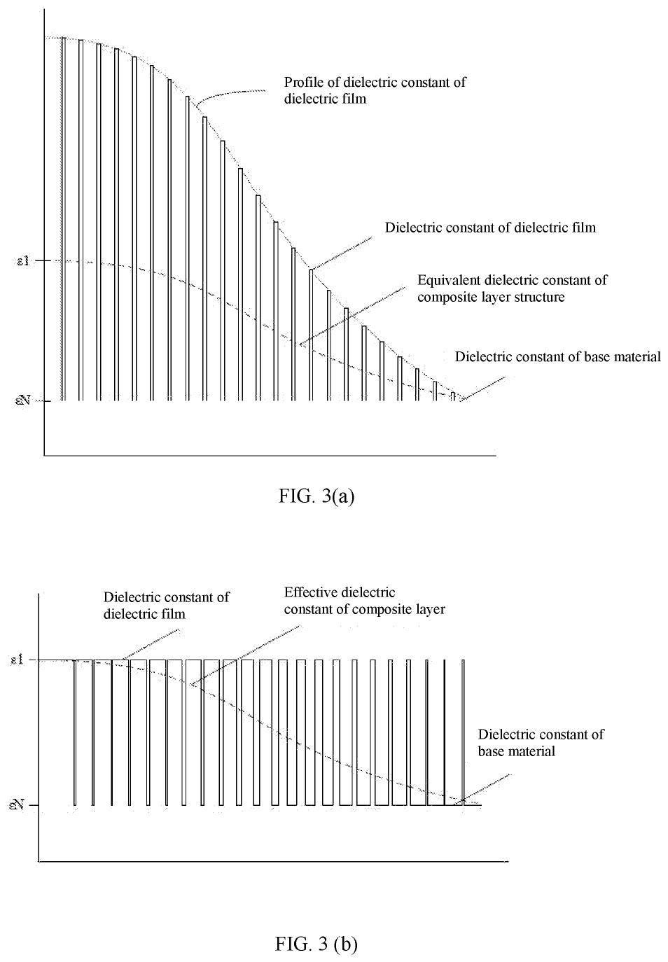

In the embodiment of the invention, FIG. 3(a) shows the dielectric constant distribution of the dielectric film with equal thickness of a dielectric cylindrical lens. The dielectric material in FIG. 3(a) includes dielectric films and low-dielectric-constant base materials, including dielectric films with the same thickness and different dielectric constants. The greater the dielectric constant of the dielectric film, the greater the equivalent dielectric constant of the dielectric material.

For the dielectric film with high dielectric constant in this embodiment, the use of high-density materials is suitable, and the thickness of each dielectric film is small, for example, the dielectric film made by common papermaking technology.

In FIG. 3(a), the abscissa is the radial position of the dielectric cylindrical lens, the dielectric constant distribution from left to right (along the radial direction) shows the thickness of the first to Nth layers of the dielectric films, and the ordinate is the dielectric constant value. In FIG. 3(a), among the dielectric materials of each layer of the composite layer structure of a dielectric cylindrical lens, the thickness of the dielectric film is the same, but the dielectric constant or equivalent dielectric constant of the dielectric film is different. The dielectric constant or equivalent dielectric constant of the dielectric film is arranged like a column as shown in the figure and gradually decreases from left to right (along the radial direction), so the equivalent dielectric constant of the composite layer structure gradually decreases along the radial direction. ε1 is the maximum equivalent dielectric constant of the dielectric cylindrical lens, that is, the equivalent dielectric constant of the composite layer structure composed of the dielectric film with the highest dielectric constant value and the low-dielectric-constant base layer. εN is the dielectric constant of the low-dielectric-constant base layer, and the equivalent dielectric constant distribution of the dielectric material composed of the dielectric film and the low-dielectric-constant base material is shown by the equivalent dielectric constant of the composite layer with dotted lines in the figure.

The dielectric material composed of high-dielectric-constant dielectric film and low-dielectric-constant base material has the advantage of low cost, but its disadvantage is that the high density material increases the lens weight.

It should be noted that in FIG. 3(a), each composite layer structure in the dielectric cylindrical lens contains one or more layers of dielectric films. When one layer of dielectric film is included, the dielectric constant of the dielectric film decreases from the center to the surface along the radial direction. When multiple layers of dielectric films are included, the equivalent dielectric constant of the multilayer dielectric film decreases from the center to the surface along the radial direction. Therefore, in the artificial dielectric cylindrical lens made of the dielectric materials composed of the above two dielectric films and base materials, the equivalent dielectric constant gradually decreases from the center to the surface along the radial direction of the cylinder.

FIG. 3 (b) shows the unequal thickness distribution of the dielectric film of a dielectric cylindrical lens, and the dielectric material of FIG. 3 (b) includes the dielectric film and low-dielectric-constant base material. For the two kinds of dielectric materials containing dielectric films with the same dielectric constant, the greater the proportion of dielectric films, the greater the equivalent dielectric constant of dielectric materials.

For low-dielectric-constant dielectric films, the use of low-density materials is suitable, such as dielectric films made by the cellulose aerosol technology. The dielectric film thickness is distributed from large to small, and the dielectric film with large thickness can be made by concentrically winding the dielectric film with small thickness. The low-dielectric-constant dielectric film in this application is relative to the high-dielectric-constant dielectric film. The dielectric constant of both the low-dielectric-constant dielectric film and the high-dielectric-constant dielectric film is higher than that of the base material.

In FIG. 3 (b), the abscissa is the radial position of the dielectric cylindrical lens, the dielectric constant distribution from left to right (along the radial direction) shows the thickness of the first to Nth layers of the dielectric films, and the ordinate is the dielectric constant value. In FIG. 3 (b), among the dielectric materials of each layer of the composite layer structure of a dielectric cylindrical lens, the parameter of the dielectric film is the same, that is, the dielectric constant or effective dielectric constant of the dielectric film is the same. The thickness of the dielectric film gradually decreases from left to right (along the radial direction), so the equivalent dielectric constant of the composite layer structure gradually decreases along the radial direction. ε1 is the maximum equivalent dielectric constant of dielectric cylindrical lens (that is, the dielectric constant of dielectric film, which forms the central cylinder), that is, the dielectric constant of the dielectric film. εN is the dielectric constant of the low-dielectric-constant base material, and the dielectric constant distribution of the dielectric film and low-dielectric-constant base material is shown by the equivalent dielectric constant curve of the composite layer with dotted lines in the figure.

The dielectric material composed of the low-dielectric-constant dielectric film and low-dielectric-constant base material has the advantage of low cost, but its disadvantage is that the high equivalent dielectric constant has a high regional cost.

It should be noted that in FIG. 3 (b), each composite layer structure in the dielectric cylindrical lens contains one or more layers of dielectric films. When one layer of dielectric film is included, the dielectric constant of the dielectric film is the same but the dielectric film thickness decreases from the center to the surface along the radial direction. When multiple layers of dielectric films are included, the equivalent dielectric constant of the multilayer dielectric film is the same but the total thickness of the multilayer dielectric film decreases from the center to the surface along the radial direction. Therefore, in the artificial dielectric cylindrical lens made of the dielectric materials composed of the above two dielectric films and base materials with different thickness, the equivalent dielectric constant gradually decreases from the center to the surface along the radial direction of the cylinder.

Further, in the dielectric material made of any one of the dielectric films shown in FIG. 3(a) or FIG. 3 (b), the number of layers of the base material may be one or more, and the number of layers of the base material in each layer of the dielectric cylindrical lens may be the same or different. Under the same conditions, the obtained equivalent dielectric constants of the dielectric materials are different when the ratio of the dielectric film to the substrate is different.

Further, each layer of dielectric material of the dielectric cylindrical lens may be a dielectric material including the dielectric film in FIG. 3(a), a dielectric material including the dielectric film in FIG. 3 (b), or a dielectric material including both the dielectric film in FIG. 3(a) and the dielectric film in FIG. 3 (b). For example, several layers in the center of the dielectric cylindrical lens adopt the composite layer structure in FIG. 3(b), and other peripheral layers adopt the composite layer structure in FIG. 3(a).

The embodiment of the invention provides two typical dielectric materials, one is a dielectric material made of the high-dielectric-constant dielectric film and low-dielectric-constant base material, with a low cost. The other is a dielectric material made of the low-dielectric-constant dielectric film and low-dielectric-constant base material, which has low density and light weight.

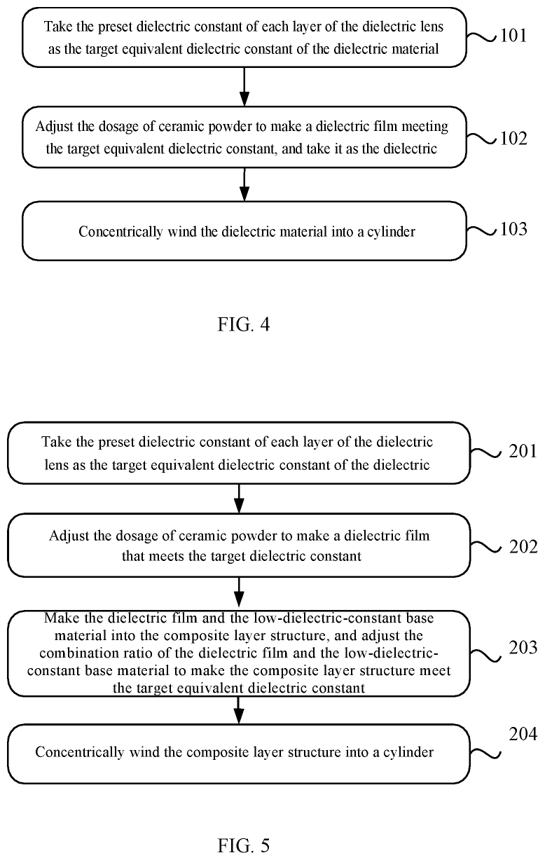

FIG. 4 is an embodiment of the fabrication method and procedure of the dielectric cylindrical lens, which is used for fabricating the dielectric cylindrical lens in the first embodiment of the invention. In the fourth embodiment of the invention, a fabrication method of the dielectric cylindrical lens includes the following steps:

Step 101, take the preset dielectric constant of each layer of the dielectric lens as the target equivalent dielectric constant of the dielectric material.

In Step 101, the radial dielectric constant distribution of the cylindrical lens is set as the target equivalent dielectric constant, and the dielectric constant distribution is discretized into N value, and the equivalent dielectric constant εn (n=1˜N) along the radial direction gradually decreases from ε1 to εN, and specifically, can vary between 2.00 and 1.00.

It should be noted that the target equivalent dielectric constant may be the same or different structure of each composite layer, and there are no special provisions in this regard here. Here, one layer of composite layer structure includes at least one layer of dielectric film and/or at least one layer of base material.

When the equivalent dielectric constant is the same in the discrete segment of the radial equivalent dielectric constant, the equivalent dielectric constant of each layer of composite layer structure in the discrete segment is the same if there are multiple layers of composite layer structure in the discrete segment.

Step 102, adjust the dosage of ceramic powder, make a dielectric film that meets the target equivalent dielectric constant, and use the dielectric film as the dielectric material.

In Step 102, the dielectric material is a dielectric film, and N specifications of dielectric materials are fabricated, and the equivalent dielectric constant of each specification of dielectric materials is εn, and n=1˜N. In other words, when the thickness of the dielectric film is small, multi-layer dielectric films are used to manufacture composite layer structures of N specifications, and the equivalent dielectric constant of each specification of composite layer structure is εn, and n=1˜N.

In Step 102, the dielectric film is further fabricated by mixing ceramic powder into cellulose solution or paper pulp.

For example, add cellulose solution into ceramic powder to produce the regenerated cellulose film, immerse the regenerated cellulose film in epoxy resin or acetone solution, and obtain the dielectric film by hot curing. Specifically, add cellulose solution into ceramic powder to produce the regenerated cellulose film, and immerse the regenerated cellulose film (RC) in epoxy resin (EP)/acetone solution, and obtain the RC/EP composite film by hot curing. With the increase of the resin content in the composite film, the water absorption of the composite material decreases, and the mechanical properties of the composite material are also greatly enhanced.

For another example, add cellulose solution into ceramic powder, mechanically stir to mix ceramic powder particles in cellulose slurry, then wash away the particles that do not enter the cavity with water, and obtain the composite cellulose aerogel through sol, gel and drying. Before stirring, add the retention aid into the filler particles and cellulose slurry, change the filler dosage, and realize the change of the dielectric constant of the finished product. The cellulose aerogel is used as the dielectric film, which has a low dielectric constant. It can be made into various specifications that meet the requirements of dielectric constant by ceramic compounding.

In Step 102, the dielectric constant of each primarily prepared dielectric film is tested by using a dielectric constant tester, and the dosage of ceramic powder is adjusted to make the prepared dielectric film conform to the target dielectric constant, so that dielectric films with various dielectric constant values can be fabricated according to predetermined specifications.

Step 103, concentrically wind the dielectric material made of the dielectric film into a cylinder. Or, concentrically wind the composite layer structure containing the dielectric film into a cylinder.

In Step 103, the dielectric films of N specifications are concentrically wound to form a cylinder, and the nth layer of the cylinder is made by winding the dielectric films of the nth specification, so that the dielectric materials present the desired distribution of the equivalent dielectric constant along the radial direction, such as the “discrete value of dielectric constant” and “design layer thickness” in Table 1.

In the embodiment of the invention, the dielectric film can use the cellulose composite material made by the cellulose aerogel technology, and the dielectric constant is between 2.00 and 1.00. The parameters of each layer of dielectric film are as follows.

TABLE 1
Example of dielectric material parameters of dielectric cylindrical lens.

| Nth layer | 1 | 2 | 3 | 4 | 5 | 6 |
|---|---|---|---|---|---|---|
| Design layer thickness | 47.7 | 30.5 | 26 | 14.2 | 27.2 | 24.5 |
| mm (radial) | | | | | | |
| Actual layer thickness | 48 | 31 | 26 | 14 | 27 | 24 |
| mm (radial) | | | | | | |
| Discrete value of | 1.85 | 1.6 | 1.45 | 1.3 | 1.15 | 1.08 |
| dielectric constant | | | | | | |
| Dielectric constant of | 1.85 ± 0.02 | 1.6 ± 0.02 | 1.45 ± 0.02 | 1.3 ± 0.02 | 1.15 ± 0.02 | 1.1 ± 0.02 |
| dielectric film | | | | | | |
| Number of dielectric | 48 | 31 | 26 | 14 | 27 | 24 |
| film layers (film | | | | | | |
| thickness 1 mm) | | | | | | |

FIG. 5 is an embodiment of the fabrication method and procedure of the dielectric cylindrical lens including the base material. The dielectric material includes the dielectric film and the low-dielectric-constant base material. As the embodiment of the invention, a fabrication method of the dielectric cylindrical lens includes the following steps:

Step 201, take the preset dielectric constant of each layer of the dielectric lens as the target equivalent dielectric constant of the dielectric material.

In Step 201, the dielectric material is a combination of the dielectric film and the low-dielectric-constant base material, and in the fabrication of composite layer structures of n specifications, the equivalent dielectric constant of the composite layer structure of each specification is εn, and n=1-N. Step 202, adjust the dosage of ceramic powder to make a dielectric film that conforms to the target dielectric constant.

The target dielectric constant refers to the dielectric constant value to be achieved by the dielectric film. Through the change of the kind and quantity of ceramic powder mixed into cellulose solution or pulp, one kind of ceramic powder or a combination of various kinds of ceramic powder can be used.

The equivalent dielectric constant of the composite layer structure, which is composed of the dielectric film with the target dielectric constant and the base material with the low dielectric constant, is the target equivalent dielectric constant of the dielectric material.

Step 203, make the dielectric film and the low-dielectric-constant base material into the composite layer structure, and adjust the combination ratio of the dielectric film and the low-dielectric-constant base material to make the composite layer structure conform to the target equivalent dielectric constant. In Step 203, in the fabrication of a composite layer structure of n specifications, the equivalent dielectric constant of the composite layer structure of each specification is εn, and n=1˜N.

In Step 203, the dielectric film and the low-dielectric-constant base material are made into a composite layer structure, and the equivalent dielectric constant is tested.

In Step 203, adjusting the combination ratio of the dielectric film and the low-dielectric-constant base material means adjusting the thickness ratio of the dielectric film and the low-dielectric-constant base material and the number of layers of the dielectric film in each layer of dielectric material, so that the equivalent dielectric constant of the nth layer of dielectric material conforms to the designed value of the nth layer of dielectric constant, and the distribution of the equivalent dielectric constant of the dielectric material conforms to the target equivalent dielectric constant. Step 204, concentrically wind the composite layer structure into a cylinder.

In Step 204, composite layer structures of N specifications are concentrically wound to form a cylinder, so that the dielectric material presents the desired distribution of the equivalent dielectric constant along the radial direction. For example, the nth layer of a cylinder is made by winding the composite layer structure of the nth specification.

In the embodiment of the invention, the parameters of the dielectric film are as follows.

TABLE 2
Examples of dielectric material parameters of dielectric cylindrical
lens containing low-dielectric-constant base material.

| Nth layer | 1 | 2 | 3 | 4 | 5 | 6 |
|---|---|---|---|---|---|---|
| Layer thickness mm | 47.7 | 30.5 | 26 | 14.2 | 27.2 | 24.5 |
| (radial) | | | | | | |
| Discrete value of | 1.85 | 1.6 | 1.45 | 1.3 | 1.15 | 1.08 |
| dielectric constant | | | | | | |
| Equivalent dielectric | 1.838 | 1.578 | 1.463 | 1.301 | 1.132 | 1.08 |
| constant of composite | | | | | | |
| layer structure | | | | | | |
| Dielectric constant | 10 | 10 | 10 | 5.5 | 5.5 | 3.5 |
| of dielectric film | | | | | | |
| Percentage of dielectric | 8.80 | 5.90 | 4.61 | 5.64 | 1.84 | 1.22 |
| film in composite layer | | | | | | |
| structure % (thickness | | | | | | |
| ratio) | | | | | | |
| Number of dielectric | 42 | 18 | 12 | 8 | 5 | 3 |
| film layers (film | | | | | | |
| thickness 0.1 mm) | | | | | | |

It should be noted that the term “including”, “containing” or any other variation thereof is intended to cover non-exclusive meanings, so that the process, method, commodity or equipment that includes a series of elements not only includes those elements, but also includes other elements not explicitly listed, or also includes elements inherent to such process, method, commodity or equipment. Without further restrictions, the elements defined by the statement “including one . . . ” do not exclude the existence of other identical elements in the process, method, commodity or equipment that includes such elements.

The above are only the preferred embodiments of the invention. It should be pointed out that those ordinary technicians in the technical field can make some improvement and modification without departing from the principle of the invention, and such improvement and modification should also be regarded as the protection scope of the invention.

1. A dielectric cylindrical lens, characterized in that the lens structure is a cylinder concentrically wound by dielectric materials;
the dielectric material is a dielectric film or a composite layer structure containing the dielectric film. The dielectric film is made by mixing ceramic powder into cellulose solution or paper pulp, and the prepared dielectric film reaches the target dielectric constant.

2. The dielectric cylindrical lens of claim 1 is characterized in that the dielectric material also comprises a low-dielectric-constant base material, and the low-dielectric-constant base material and the dielectric film are combined into a composite layer structure by epoxy resin glue.

3. The dielectric cylindrical lens of claim 1 is characterized in that the dielectric constant of the dielectric film gradually decreases along the radial direction of the cylinder.

4. The dielectric cylindrical lens of claim 1 is characterized in that the ceramic powder is titanate ceramic powder.

5. The dielectric cylindrical lens of claim 1 is characterized in that the height of the dielectric cylindrical lens is 20-70 cm and the diameter is 20-90 cm.

6. The dielectric cylindrical lens of claim 2 is characterized in that the low-dielectric-constant base material is sponge foamed paper with a thickness of 0.5˜5 mm, and the thickness of the composite layer structure is 0.6˜12 mm.

7. A fabrication method of the dielectric film, which is used for fabricating the dielectric cylindrical lens as described in claim 1, and is characterized by the following steps:
add cellulose solution into ceramic powder to produce the regenerated cellulose film, immerse the regenerated cellulose film in epoxy resin or acetone solution, and obtain the dielectric film by hot curing.

8. A fabrication method of the dielectric film, which is used for fabricating the dielectric cylindrical as described in claim 1, and is characterized by the following steps:
add cellulose solution into ceramic powder, mechanically stir to mix ceramic powder particles in cellulose slurry, wash with water to remove particles that do not enter the cavity, and prepare the dielectric film through sol, gel and drying.

9. A fabrication method of the dielectric cylindrical lens, which is used for fabricating the dielectric cylindrical as described in claim 1, and is characterized by the following steps:
take the preset dielectric constant of each layer of the dielectric lens as the target equivalent dielectric constant of the dielectric material;
adjust the dosage of ceramic powder to make a dielectric film meeting the target equivalent dielectric constant, and take it as the dielectric material;
concentrically wind the dielectric material into a cylinder.

10. A fabrication method of the dielectric cylindrical lens, which is used for fabricating the dielectric cylindrical lens as described in claim 1, and is characterized by the following steps:
take the preset dielectric constant of each layer of the dielectric lens as the target equivalent dielectric constant of the dielectric material;
make the dielectric film and the low-dielectric-constant base material into the composite layer structure, and adjust the combination ratio of the dielectric film and the low-dielectric-constant base material to make the composite layer structure conform to the target equivalent dielectric constant;
concentrically wind the composite layer structure into a cylinder.
